(19) United States
(12) Patent Application Publication
(10) Pub. No.: US 2024/0360281 A1
(43) Pub. Date: Oct. 31, 2024

(54) CURABLE COMPOSITION AND ADHESIVE

(71) Applicant: Panasonic Intellectual Property Management Co., Ltd., Osaka (JP)

(72) Inventors: Hiroki SHINOZAKI, Mie (JP); Takahiro WAKAIKI, Mie (JP)

(21) Appl. No.: 18/688,288

(22) PCT Filed: Aug. 18, 2022
(86) PCT No.: PCT/JP2022/031277

§ 371 Date: Feb. 29, 2024

(30) Foreign Application Priority Data
Sep. 3, 2021 (JP) 2021-144327

(51) Int. Cl. C08G 75/045; C08K 3/26; C08K 3/36; C08K 5/07; C08K 5/29; C08K 5/32; C08K 5/5397; C08K 5/55; C09J 11/04; C09J 11/06; C09J 11/08; C09J 181/02

(52) U.S. Cl. CPC C08G 75/045; C08K 3/36; C08K 5/07; C08K 5/29; C08K 5/32; C08K 5/5397; C08K 5/55; C09J 11/04; C09J 11/06; C09J 11/08; C09J 181/02; C08G 2170/00; C08K 2003/265

(57) ABSTRACT

A curable composition according to the present disclosure contains: a curable component (A) including an ene compound (A1) and a thiol compound (A2); a filler (C); and an anion polymerization initiator (D). The filler (C) contains silicone powder (C1). The anion polymerization initiator (D) contains a microencapsulated curing catalyst (D1).

### TECHNICAL FIELD

The present disclosure relates to curable compositions and adhesives and specifically relates to a curable composition containing an ene compound and a thiol compound and an adhesive containing the curable composition.

### BACKGROUND ART

An example of a composition used as an adhesive is an adhesive containing an ene compound and a thiol compound. A cured material of such an adhesive can be flexible. For example, Patent Literature 1 discloses a resin composition containing an acrylic resin, a thiol compound, a latent curing agent, a radical polymerization inhibitor, and an anion polymerization inhibitor (see Patent Literature 1).

### CITATION LIST

### Patent Literature

Patent Literature 1: JP 4976575 B1

### SUMMARY OF INVENTION

It is an object of the present disclosure to provide a curable composition and an adhesive containing the curable composition, the curable composition containing an ene compound and a thiol compound, a cured material obtained by curing the curable composition being able to be highly flexible, preservation stability of the curable composition being less likely to be impaired.

A curable composition according to an aspect of the present disclosure contains a curable component (A) including an ene compound (A1) and a thiol compound (A2), a stabilizer (B), a filler (C), and an anion polymerization initiator (D). The filler (C) contains silicone powder (C1). The anion polymerization initiator (D) contains a microencapsulated curing catalyst (D1).

An adhesive according to an aspect of the present disclosure contains the curable composition.

### DESCRIPTION OF EMBODIMENTS

An example of a composition used as an adhesive is an adhesive containing an ene compound and a thiol compound. A cured material of such an adhesive can be flexible.

According to research conducted by the inventors, in particular, adhesives of camera module applications in smartphones require more and more flexibility for cured materials of the adhesives to withstand the impact test by dropping.

The inventors, however, uniquely proceeded with research and development of compositions used as adhesives and consequently found that blending silicone powder into a composition containing an ene compound and a thiol compound to improve flexibility reduced the preservation stability of the composition.

Therefore, the inventors proceeded with research and development to provide a curable composition containing an ene compound and a thiol compound, a cured material obtained by curing the curable composition being able to be highly flexible, preservation stability of the curable composition being less likely to be impaired, and the inventors accomplished the present disclosure. Note that the process of the development does not limit the contents of the present disclosure.

An embodiment of the present disclosure will be described below. Note that the following embodiment is a mere example of various embodiments of the present disclosure. The following embodiment may be variously modified depending on design as long as the object of the present disclosure is achieved.

The curable composition according to the present embodiment is preferably used as an adhesive and is more preferably used to bond components to each other in a precision instrument such as a camera module. Note that when used as an adhesive, the curable composition may be used to bond any objects, that is, application of the curable composition is not limited to bonding components to each other in a precision instrument such as a camera module. Moreover, the curable composition according to the present embodiment may be applied to application other than the adhesive and may be used, for example, as a sealing agent for electronic components.

The curable composition (hereinafter also referred to as a composition (X)) according to the present embodiment contains a curable component (A) including an ene compound (A1) and a thiol compound (A2), a stabilizer (B), a filler (C), and an anion polymerization initiator (D). The filler (C) contains silicone powder (C1). The anion polymerization initiator (D) contains a microencapsulated curing catalyst (D1).

Since the composition (X) contains the stabilizer (B), the composition (X) can have good preservation stability. Moreover, since the composition (X) contains the silicone powder (C1), a cured material of the composition (X) can be highly flexible. Further, the composition (X) contains the silicone powder (C1), but since the composition (X) contains the microencapsulated curing catalyst (D1), the preservation stability of the composition (X) is less likely to be impaired.

A reason why the silicone powder (C1) impairs the preservation stability of the composition (X) and a reason why the microencapsulated curing catalyst (D1) suppresses the preservation stability from being reduced due to the silicone powder (C1) have not been satisfactorily revealed but are inferred as follows. Note that the following reasons do not limit the configuration and the operation of the composition (X) according to the present embodiment. If a composition containing an ene compound and a thiol compound contains the silicone powder (C1) and a latent curing catalyst such as an amine adduct-based latent curing catalyst, the preservation stability of the composition would be expected to be improved by the latent curing catalyst, but the preservation stability of the composition is actually not satisfactorily improved. This is presumably because the pH of the silicone powder (C1) is low, and therefore, not only the thiol compound (A2) but also the silicone powder (C1) is deprotonated by the latent curing catalyst such as the amine adduct-based latent curing catalyst, thereby achieving a state where a reaction with the ene compound (A1) is further promoted, and consequently, even an ordinary temperature causes the reaction to proceed and thereby increasing the viscosity. In contrast, it can be presumed that in the present embodiment, the composition (X) contains the microencapsulated curing catalyst (D1), and the activity of the microencapsulated curing catalyst (D1) is less likely to be influenced by the pH of the silicone powder (C1), and therefore, the preservation stability of the composition (X) is less likely to be impaired by the silicone powder (C1). Note that the pH of the silicone powder (C1) is measured by immersing an electrode of a pH meter in a test solution at 25° C. The test solution is a filtrate obtained by stirring a mixture obtained by adding 100 g of ion-exchanged water to 10 g of the silicone powder (C1), then processing the mixture for 15 hours in a thermostatic device at 95° C., leaving the mixture to be cooled to a room temperature, and filtering the mixture. In the present embodiment, in particular, when the pH of the silicone powder (C1) is greater than or equal to 5.5 and less than or equal to 7.5, the preservation stability is suppressed from being reduced due to the silicone powder (C1).

Details of the components included in the composition (X) will be described.

The ene compound (A1) and the thiol compound (A2) are reaction curable components for curing the composition (X).

The ene compound (A1) contains, for example, at least one of a compound including at least one of an acryloyl group or a methacryloyl group (hereinafter referred to as an acryl compound) or a compound including a vinyl group (hereinafter referred to as a vinyl compound).

The acryl compound contains, for example, at least one selected from the group consisting of trimethylolpropane triacrylate, 1,6-hexane diol diacrylate, dimethylol-tricyclodecane diacrylate, acryloyl morpholine, tetrahydro furfuryl acrylate, 4-hydroxy butyl acrylate, tris-(2-acryloxyethyl) isocyanurate, bis-(2-acryloxyethyl) isocyanurate, caprolactone denatured tris-(2-acryloxyethyl) isocyanurate, isocyanuric acid EO modified diacrylate, isocyanuric acid EO modified triacrylate, and the like.

The vinyl compound contains at least one selected from the group consisting of triallyl isocyanurate, allyl glycidyl ether, trimethylolpropane diallyl ether, pentaerythritol triallyl ether, and the like.

The ene compound (A1) preferably contains a compound having an isocyanurate skeleton. In this case, the adhesive strength of the cured material of the composition (X) in the case of applying the composition (X) to the adhesive can increase. In this case, the ene compound (A1) preferably contains at least one selected from the group consisting of tris-(2-acryloxyethyl) isocyanurate, bis-(2-acryloxyethyl) isocyanurate, caprolactone denatured tris-(2-acryloxyethyl) isocyanurate, isocyanuric acid EO modified diacrylate, isocyanuric acid EO modified triacrylate, and triallyl isocyanurate.

Compounds which the ene compound (A1) may contain are not limited to the above examples, but the ene compound (A1) may contain various kinds of compounds having an ethylenically unsaturated bond.

The thiol compound (A2) preferably contains a compound having at least two thiol groups per molecule. The thiol compound (A2) more preferably contains a compound including greater than or equal to three and less than or equal to six thiol groups per molecule.

The thiol compound (A2) contains, for example, an ester of polyol and mercapto organic acid. This ester contains at least one of a partial ester or a complete ester.

The polyol includes, for example, at least one selected from the group consisting of ethylene glycol, trimethylolpropane, pentaerythritol, dipentaerythritol, and the like.

The mercapto organic acid includes at least one selected from the group consisting of mercapto aliphatic monocarboxylic acid, an ester containing a carboxy group and a thiol group obtained by esterification reaction of hydroxy acid and mercapto organic acid, mercapto aliphatic dicarboxylic acid, mercapto aromatic monocarboxylic acid, and the like. The mercapto aliphatic monocarboxylic acid includes, for example, at least one selected from the group consisting of mercaptoacetic acid: mercaptopropionic acid such as 3-mercaptopropionic acid: mercaptobutyric acid such as 3-mercaptobutyric acid and 4-mercaptobutyric acid; and the like. The carbon number of the mercapto aliphatic monocarboxylic acid is preferably 2 to 8, more preferably 2 to 6, much more preferably 2 to 4, and particularly preferably 3. The mercapto aliphatic monocarboxylic acid of from 2 to 8 carbon atoms includes, for example, at least one selected from the group consisting of mercaptoacetic acid, 3-mercaptopropionic acid, 3-mercaptobutyric acid, and 4-mercaptobutyric acid. The mercapto aliphatic dicarboxylic acid includes, for example, at least one selected from the group consisting of mercaptosuccinic acid, dimercaptosuccinic acid such as 2,3-dimercaptosuccinic acid, and the like. The mercapto aromatic monocarboxylic acid includes, for example, mercapto benzoic acid such as 4-mercapto benzoic acid.

The partial ester of the polyol and the mercapto organic acid includes, for example, at least one selected from the group consisting of trimethylolpropane bis(mercaptoacetate), trimethylolpropane bis(3-mercaptopropionate), trimethylolpropane bis(3-mercaptobutyrate), trimethylolpropane bis(4-mercaptobutyrate), pentaerythritol tris(mercaptoacetate), pentaerythritol tris(3-mercaptopropionate), pentaerythritol tris(3-mercaptobutyrate), pentaerythritol tris(4-mercaptobutyrate), dipentaerythritol tetrakis(mercaptoacetate), dipentaerythritol tetrakis(3-mercaptopropionate), dipentaerythritol tetrakis(3-mercaptobutyrate), dipentaerythritol tetrakis(4-mercaptobutyrate), and the like.

Examples of the complete ester of the polyol and the mercapto organic acid include ethylene glycol bis(mercaptoacetate), ethylene glycol bis(3-mercaptopropionate), ethylene glycol bis(3-mercaptobutyrate), ethylene glycol bis(4-mercaptobutyrate), trimethylolpropane tris(mercaptoacetate), trimethylolpropane tris(3-mercaptopropionate), trimethylolpropane tris(3-mercaptobutyrate), trimethylolpropane tris(4-mercaptobutyrate), pentaerythritol tetrakis(mercaptoacetate), pentaerythritol tetrakis(3-mercaptopropionate), pentaerythritol tetrakis(3-mercaptobutyrate), pentaerythritol tetrakis(4-mercaptobutyrate), dipentaerythritol hexakis (mercaptoacetate), dipentaerythritol hexakis (3-mercaptopropionate), dipentaerythritol hexakis (3-mercaptobutyrate), and dipentaerythritol hexakis (4-mercaptobutyrate). The complete ester of the polyol and the mercapto organic acid preferably includes at least one selected from the group consisting of pentaerythritol tetrakis(3-mercaptopropionate), pentaerythritol tetrakis(3-mercaptobutyrate), dipentaerythritol hexakis (3-mercaptopropionate), and trimethylolpropane tris(3-mercaptopropionate).

The thiol compound (A2) may include tris [(3-mercaptopropionyloxy)-ethyl]-isocyanurate, 1,3,5-tris(3-mercaptobutyloxyethyl)-1,3,5-triazine-2,4,6(1H,3H,5H)-trione, etc.

The thiol compound (A2) may contain a compound other than the above examples. For example, the thiol compound (A2) may contain at least one selected from the group consisting of 1,4-butanedithiol, 1,6-hexanedithiol, 1,8-octanedithiol, 1,10-decanedithiol, 3,6-dioxa-1,8-octanedithiol, bis-2-mercaptoethylsulfide, and the like. The thiol compound (A2) may contain at least one selected from the group consisting of tris(3-mercapto propyl) isocyanurate, 1,3,5-tris [3-(2-mercaptoethylsulfanyl) propyl]isocyanurate, 1,3,4,6-tetrakis(2-mercaptoethyl) glycoluril, and the like.

The thiol compound (A2) preferably contains a compound having a secondary thiol group. For example, the thiol compound (A2) preferably contains at least one selected from the group consisting of pentaerythritol tetrakis(3-mercaptobutyrate), 1,4-bis(3-mercaptobutyryloxy)butane, 1,3,5-tris(2-(3-sulfanylbutanoyloxy)ethyl)-1,3,5-triazinane-2,4,6-trione, and trimethylolpropane tris(3-mercaptobutyrate). The compound having the secondary thiol group can improve the preservation stability of the composition (X) as compared with a compound having a primary thiol group.

The percentage of the sum of the ene compound (A1) and thiol compound (A2) is preferably greater than or equal to 70% by mass relative to a portion obtained by excluding the filler (C) from a solid content of the composition (X). In this case, the composition (X) can have good reaction curability. This percentage is more preferably greater than or equal to 80% by mass, and much more preferably greater than or equal to 90% by mass. Moreover, this percentage is, for example, less than or equal to 97% by mass. Note that the solid content means a component except for a volatile component in the composition (X). The volatile component means a component which volatilizes during the process of curing the composition (X) to produce a cured material and which is therefore not included in the cured material, and the volatile component is for example, a solvent.

Moreover, for a compound ratio between the ene compound (A1) and the thiol compound (A2), a thiol compound (A2)/ene compound (A1) equivalent ratio (i.e., a functional group equivalent ratio of the thiol compound (A2) to ene compound (A1)) is preferably greater than or equal to 0.5 and less than or equal to 1.5. This compound ratio is more preferably greater than or equal to 0.7 and less than or equal to 1.3, and much more preferably greater than or equal to 0.85 and less than or equal to 1.15.

The reaction curable component in the composition (X) may be only the ene compound (A1) and the thiol compound (A2). The composition (X) may contain a reaction curable component (hereinafter referred to as a component (A3)) other than the ene compound (A1) and the thiol compound (A2) within a range in which the effect of the present embodiment is not excessively impaired. When the composition (X) contains the component (A3), the percentage of the component (A3) relative to the ene compound (A1) is preferably greater than 0% by mass and less than or equal to 70% by mass. This percentage is more preferably less than or equal to 50% by mass, and much more preferably less than or equal to 30% by mass. Examples of a compound included in the component (A3) include an epoxy compound, an oxetane compound, a phenol compound, and an amine compound.

The composition (X) contains the stabilizer (B) as described above. The stabilizer (B) is a compound which retards a reaction between the ene compound (A1) and the thiol compound (A2) which are reactive components in the composition (X). When the composition (X) contains the stabilizer (B), the preservation stability of the composition (X) can increase.

The stabilizer (B) preferably contains at least one of a radical polymerization inhibitor or an anion polymerization inhibitor. In this case, the preservation stability of the composition (X) can further increase. This is presumably because while the composition (X) is stored, the radical polymerization inhibitor retards the radical polymerization reaction between the ene compound (A1) and the thiol compound (A2) and the radical polymerization reaction between molecules in the ene compound (A1), and the anion polymerization inhibitor retards an anion polymerization reaction between the ene compound (A1) and the thiol compound (A2).

In the present embodiment, the composition (X) contains the anion polymerization initiator (D), and therefore, the stabilizer (B) preferably contains the anion polymerization inhibitor. In this case, the anion polymerization inhibitor suppresses the anion polymerization reaction during storage of the composition (X) from proceeding due to the anion polymerization initiator (D), and therefore, the preservation stability of the composition (X) can particularly improve.

Moreover, in the present embodiment, when the composition (X) contains a radical polymerization initiator (F) described later, the stabilizer (B) preferably contains the radical polymerization inhibitor. In this case, the radical polymerization inhibitor suppresses the radical polymerization reaction during storage of the composition (X) from proceeding due to the radical polymerization initiator (F), and therefore, the preservation stability of the composition (X) can particularly improve. The stabilizer (B) may include both the anion polymerization inhibitor and the radical polymerization inhibitor.

The radical polymerization inhibitor can include, for example, at least one compound selected from the group consisting of 4-tert-butyl pyrocatechol, tert-butyl hydroquinone, 1,4-benzoquinone, dibutyl hydroxy toluene, 1,1-diphenyl-2-picrylhydrazyl free radical, hydroquinone, hydroquinone monomethyl ether, mequinol, phenothiazine, N-nitroso-N-phenyl hydroxyl amine aluminum, and the like. Note that compounds which the radical polymerization inhibitor may contain are not limited to the above examples.

The anion polymerization inhibitor contains, for example, at least one of an organoborate compound or a compound having a phenolic hydroxyl group. The organoborate compound contains, for example, at least one ester borate selected from the group consisting of triethyl borate, tributyl borate, triisopropyl borate, and the like. The compound having a phenolic hydroxyl group contains, for example, at least one selected from the group consisting of 2.3-dihydroxynaphthalene, 4-methoxy-1-naphthol, pyrogallol, methyl hydroquinone, t-butyl hydroquinone, and the like.

The percentage of the stabilizer (B) relative to the sum of the ene compound (A1), the thiol compound (A2), the stabilizer (B), and the anion polymerization initiator (D) is preferably greater than or equal to 0.01% by mass and less than or equal to 1.5% by mass. When this percentage is greater than or equal to 0.01% by mass, the preservation stability of the composition (X) can further improve. When the percentage is less than or equal to 1.5% by mass, there is the advantage that the curability of the composition (X) is less likely to be impaired, and high adhesive strength is maintained when the composition (X) is cured under an appropriate condition. This percentage is more preferably greater than or equal to 0.05% by mass, much more preferably greater than or equal to 0.1% by mass, and particularly preferably greater than or equal to 0.2% by mass. Further, this percentage is more preferably less than or equal to 1.2% by mass, more preferably less than or equal to 1.0% by mass, and particularly preferably less than or equal to 0.7% by mass.

When the stabilizer (B) contains the radical polymerization inhibitor, the percentage of the radical polymerization inhibitor relative to the sum of the ene compound (A1), the thiol compound (A2), the stabilizer (B), and the anion polymerization initiator (D) is preferably greater than or equal to 0.01% by mass and less than or equal to 1.5% by mass. When this percentage is greater than or equal to 0.01% by mass, the preservation stability of the composition (X) can further improve. When the percentage is less than or equal to 1.5% by mass, there is the advantage that the curability of the composition (X) is less likely to be impaired, and high adhesive strength is maintained when the composition (X) is cured under an appropriate condition. This percentage is more preferably greater than or equal to 0.03% by mass, much more preferably greater than or equal to 0.05% by mass, and particularly preferably greater than or equal to 0.1% by mass. Moreover, this percentage is more preferably less than or equal to 1.0% by mass, much more preferably less than or equal to 0.5% by mass, and particularly preferably less than or equal to 0.25% by mass.

When the stabilizer (B) contains the anion polymerization inhibitor, the percentage of the anion polymerization inhibitor relative to the sum of the ene compound (A1), the thiol compound (A2), the stabilizer (B), and the anion polymerization initiator (D) is preferably greater than or equal to 0.01% by mass and less than or equal to 1.5% by mass. When this percentage is greater than or equal to 0.01% by mass, the preservation stability of the composition (X) can further improve. When the percentage is less than or equal to 1.5% by mass, there is the advantage that the curability of the composition (X) is less likely to be impaired, and high adhesive strength is maintained when the composition (X) is cured under an appropriate condition. This percentage is more preferably greater than or equal to 0.05% by mass, much more preferably greater than or equal to 0.1% by mass, and particularly preferably greater than or equal to 0.15% by mass. Moreover, this percentage is more preferably less than or equal to 1.2% by mass, much more preferably less than or equal to 1.0% by mass, and particularly preferably less than or equal to 0.5% by mass.

The filler (C) can reduce curing shrinkage while the composition (X) cures. As described above, the filler (C) contains the silicone powder (C1). Thus, the cured material can be satisfactorily flexible. In particular, the elastic modulus of a reaction product of the ene compound (A1) and the thiol compound (A2) can increase at a low temperature, but when the composition (X) contains the silicone powder (C1), the elastic modulus of the cured material of the composition (X) is less likely to increase even at a low temperature. Therefore, the cured material can have a low elastic modulus in a wide temperature range of, for example, from −40° C. to 120° C.

The silicone powder (C1) contains, for example, at least one selected from the group consisting of powder of silicone rubber (silicone rubber powder), powder of a silicone resin (silicone resin powder), and powder including a core made of the silicone rubber and a shell made of the silicone resin (silicone composite powder). Note that the silicone resin is a silicone having a skeleton including a three-dimensional siloxane bond as a main body, and the silicone rubber is a silicone having a skeleton including a two-dimensional siloxane bond as a main body.

The silicone powder (C1) preferably contains at least one of the silicone resin powder or the silicone composite powder. In this case, the cured material of the composition (X) can further have a low elastic modulus in the wide temperature range.

The average particle size of the silicone powder (C1) is preferably greater than or equal to 0.3 μm and less than or equal to 30 μm. When the average particle size is greater than or equal to 0.3 μm, there is the advantage that the viscosity of the composition (X) is suppressed from excessively increasing. When the average particle size is less than or equal to 30 μm, there is the advantage that a high infiltration property of the composition (X) into a narrow space can be maintained. This average particle size is more preferably greater than or equal to 0.5 μm, and much more preferably greater than or equal to 0.7 μm. Moreover, this average particle size is more preferably less than or equal to 20 μm, and much more preferably less than or equal to 10 μm. Note that the average particle size is a particle size (d50) corresponding to the cumulative frequency of 50% calculated from volume-based particle size distribution measured by a laser diffraction method.

The percentage of the filler (C) relative to the solid content of the composition (X) is preferably greater than or equal to 10% by mass and less than or equal to 65% by mass. In this case, the curing shrinkage while the composition (X) cures can effectively decrease. This percentage is more preferably greater than or equal to 15% by mass and less than or equal to 50% by mass, and much more preferably greater than or equal to 20% by mass and less than or equal to 40% by mass.

The percentage of the silicone powder (C1) relative to the filler (C) is preferably greater than or equal to 70% by mass and less than or equal to 100% by mass. When this percentage is greater than or equal to 70% by mass, the flexibility of the cured material can particularly improve.

The percentage of the silicone powder (C1) relative to the solid content of the composition (X) is preferably greater than or equal to 15% by mass and less than or equal to 50% by mass. When the percentage is greater than or equal to 15% by mass, the flexibility of the cured material particularly increases, and the curing shrinkage can decrease. Moreover, when the percentage is less than or equal to 50% by mass, there is the advantage that the viscosity of the composition (X) is suppressed from excessively increasing. This percentage is more preferably greater than or equal to 20% by mass, much more preferably greater than or equal to 23% by mass, and particularly preferably greater than or equal to 27% by mass. Moreover, this percentage is more preferably less than or equal to 45% by mass, much more preferably less than or equal to 40% by mass, and particularly preferably less than or equal to 35% by mass.

The filler (C) may contain only the silicone powder (C1) or may further contain a filler (hereinafter also referred to as a filler (C2)) other than the silicone powder (C1).

The filler (C2) may contain an inorganic filler. The filler (C2) may contain only the inorganic filler. When the composition (X) contains the inorganic filler, curing shrinkage is less likely to be caused in the process of curing the composition (X) to produce the cured material. Thus, the composition (X) is more suitable to an adhesion for components in a precision instrument such as a camera module. The inorganic filler contains, for example, at least one selected from the group consisting of silica, alumina, barium sulfate, talc, clay, mica, aluminum hydroxide, magnesium hydroxide, calcium carbonate, magnesium carbonate, magnesium oxide, boron nitride, aluminum borate, barium titanate, strontium titanate, calcium titanate, magnesium titanate, bismuth titanate, titanium oxide, barium zirconate, calcium zirconate, and the like.

When the filler (C) contains the filler (C2) other than the silicone powder (C1), the percentage of the filler (C2) relative to the solid content of the composition (X) is, for example, greater than 0% by mass and less than or equal to 30% by mass.

As described above, the composition (X) contains the anion polymerization initiator (D), and the anion polymerization initiator (D) contains a microencapsulated anion polymerization initiator (microencapsulated curing catalyst (D1)). The microencapsulated curing catalyst (D1) may be regarded as a kind of a latent curing catalyst (latent anion polymerization initiator). The microencapsulated curing catalyst (D1) includes a core made of a catalytically active compound and a shell covering the core. The shell is made of, for example, at least one of an organic polymer or an inorganic compound. The microencapsulated curing catalyst (D1) contains, for example, microencapsulation imidazole including imidazoles as the catalytically active compound.

The percentage of the microencapsulated curing catalyst (D1) relative to the sum of the ene compound (A1) and the thiol compound (A2) is preferably greater than or equal to 1% by mass and less than or equal to 35% by mass. When this percentage is greater than or equal to 1% by mass, the reactivity of the composition (X) when reaction of the composition (X) is caused to cure the composition (X) can be enhanced. Moreover, when the percentage is less than or equal to 35% by mass, the preservation stability of the composition (X) can further increase. This percentage is more preferably greater than or equal to 3% by mass, much more preferably greater than or equal to 5% by mass, and particularly preferably greater than or equal to 7% by mass. Moreover, this percentage is more preferably less than or equal to 30% by mass, much more preferably less than or equal to 25% by mass, and particularly preferably less than or equal to 20% by mass.

The anion polymerization initiator (D) preferably contains only the microencapsulated curing catalyst (D1). Moreover, the anion polymerization initiator (D) may further contain an anion polymerization initiator (hereinafter referred to as a curing catalyst (D2)) other than the microencapsulated curing catalyst (D1) within a range in which the preservation stability of the present embodiment is not excessively impaired. The curing catalyst (D2) contains, for example, at least one of an anion polymerization initiator other than the latent curing catalyst (latent anion polymerization initiator) or a latent curing catalyst (latent anion polymerization initiator) other than the microencapsulated curing catalyst (D1). The anion polymerization initiator other than the latent curing catalyst contains, for example, at least one component selected from the group consisting of imidazoles, cycloamidines, tertiary amines, organic phosphines, tetra-substituted phosphonium tetra-substituted borate, quaternary phosphonium salt having a pairing anion other than borate, tetraphenylborate, and the like. The latent curing catalyst other than the microencapsulated curing catalyst (D1) can contain, for example, at least one of a solid substance-dispersible latent curing accelerator or a liquiform latent curing accelerator other than the microencapsulated curing catalyst (D1). The percentage of the curing catalyst (D2) relative to the anion polymerization initiator (D) is preferably less than or equal to 1% by mass and more preferably less than or equal to 0.1% by mass.

The composition (X) may contain a carbodiimide compound (E). In this case, the cured material of the composition (X) is less likely to be degraded even at a high temperature and a high humidity, and the reliability of the cured material can increase.

The carbodiimide compound (E) is a compound having a carbodiimide group (—N═C═N—) in a molecule. The carbodiimide compound can include at least one selected from the group consisting of polycarbodiimide, monocarbodiimide, and annular carbodiimide. The polycarbodiimide can include at least one of aliphatic polycarbodiimide or aromatic polycarbodiimide. The aliphatic polycarbodiimide has a main chain including aliphatic carbon hydride. The aromatic polycarbodiimide has a main chain including aromatic carbon hydride. The monocarbodiimide can include at least one of aliphatic monocarbodiimide or aromatic monocarbodiimide.

The monocarbodiimide contains, for example, at least one selected from the group consisting of N,N′-di-o-toluyl carbodiimide, N,N′-diphenyl carbodiimide, N,N′-di-2,6-dimethyl phenyl carbodiimide, N,N′-bis(2,6-diisopropyl phenyl) carbodiimide, N,N′-bis(propyl phenyl) carbodiimide, N,N′-dioctyl decyl carbodiimide, N-triyl-N′-cyclohexyl carbodiimide, N,N′-di-2,2-di-tert-butyl phenyl carbodiimide, N-triyl-N′-phenyl carbodiimide, N,N′-di-p-nitrophenyl carbodiimide, N,N′-di-p-amino phenyl carbodiimide, N,N′-di-p-hydroxy phenyl carbodiimide, N,N′-dicyclohexyl carbodiimide, N,N′-di-p-toluyl carbodiimide, and the like.

The polycarbodiimide is, for example, a compound represented by the below-described formula.

R²—(—N═C═N—R¹—)ₘ—R³

In the formula, m R¹ groups are each independently a bivalent aromatic group or an aliphatic group. When R¹ is the aromatic group, R¹ may be substituted with at least one of an aliphatic substitution group, an alicyclic substitution group, or an aromatic substitution group having at least one carbon atom. Those substitution groups may have a heteroatom, or those substitution groups may be substituted at least one ortho position of an aromatic group to which a carbodiimide group bonds. R² is an alkyl group of from 1 to 18 carbon atoms, a cycloalkyl group of from 5 to 18 carbon atoms, an aryl group, an aralkyl group of from 7 to 18 carbon atoms, —R⁴—NH—COS—R⁵, —R⁴COOR⁵, —R⁴—OR⁵, —R⁴—N(R⁵)₂, —R⁴—SR⁵, —R⁴—OH, —R⁴—NH₂, —R⁴—NHR⁵, —R⁴-epoxy, —R⁴—NCO, —R⁴—NHCONHR⁵, —R⁴—NHCONR⁵R⁶ or —R⁴—NHCOOR⁷. R³ is —N═C═N-aryl, —N═C═N-alkyl, —N═C═N-cyclo alkyl, —N═C═N-aralkyl, —NCO, —NHCONHR⁵, —NHCONHR⁵R⁶, —NHCOOR⁷, —NHCOS—R⁵, —COOR⁵, —OR⁵, epoxy, —N(R⁵)₂, —SR, —OH, —NH₂, or —NHRS. R⁴ is a bivalent aromatic group or aliphatic group. R⁵ and R⁶ are each independently an alkyl group of from 1 to 20 carbon atoms, a cycloalkyl group of from 3 to 20 carbon atoms, an aralkyl group of from 7 to 18 carbon atoms, oligo/polyethylene glycols, or oligo/polypropylene glycols. R⁷ has one of the definitions for R⁵ or is a polyester group or a polyamide group. m is an integer greater than or equal to 2.

The polycarbodiimide includes, for example, at least one selected from the group consisting of poly(4,4′-dicyclohexyl methane carbodiimide), poly(N,N′-di-2,6-diisopropyl phenyl carbodiimide), poly(1,3,5-triisopropylphenylene-2,4-carbodiimide), and the like. Examples of a commercially available product of the polycarbodiimide include at least one selected from the group consisting of aliphatic polycarbodiimide (manufactured by Nisshinbo Chemical Inc., Elastostab H-01), carbodiimide denatured isocyanate (manufactured by Nisshinbo Chemical Inc., CARBODILITE V-05), and the like.

The annular carbodiimide includes: one carbodiimide group per molecule; and a group (bonding group) bonded to both of two nitrogen atoms (a first nitrogen atom and a second nitrogen atom) in the carbodiimide group. The bonding group is, for example, a bivalent group selected from an aliphatic group, an alicyclic group, an aromatic group, and combinations thereof. The bonding group may include a heteroatom. The aromatic group is, for example, selected from the group consisting of an arylene group of from 5 to 15 carbon atoms, an arene triyl group of from 5 to 15 carbon atoms, and an arenetetrayl group of from 5 to 15 carbon atoms. The aliphatic group is, for example, selected from the group consisting of an alkylene group of from 1 to 20 carbon atoms, an alkane triyl group of from 1 to 20 carbon atoms, and an alkanetetrayl group of from 1 to 20 carbon atoms. The alicyclic group is, for example, selected from the group consisting of a cycloalkylene group of from 3 to 20 carbon atoms, a cycloalkanetriyl group of from 3 to 20 carbon atoms, and a cycloalkanetetrayl group of from 3 to 20 carbon atoms.

The carbodiimide compound (E) preferably contains the annular carbodiimide. In this case, there is the advantage that the preservation stability of the composition (X) is much less likely to be impaired and that the adhesive strength of the cured material can further improve.

The percentage of the carbodiimide compound (E) relative to the sum of the ene compound (A1) and the thiol compound (A2) is preferably greater than or equal to 1% by mass and less than or equal to 20% by mass. When this percentage is greater than or equal to 1% by mass, the reliability of the cured material can particularly increase. When this proportion is less than or equal to 20% by mass, the curability of a deep part of the composition (X) when the composition (X) cures can be maintained. This percentage is more preferably greater than or equal to 3% by mass, much more preferably greater than or equal to 5% by mass, and particularly preferably greater than or equal to 7% by mass. Moreover, this percentage is more preferably less than or equal to 15% by mass, much more preferably less than or equal to 12% by mass, and particularly preferably less than or equal to 10% by mass.

The composition (X) may further contain the radical polymerization initiator (F). The radical polymerization initiator (F) can impart a photocurable property to the composition (X). In particular, when the composition (X) contains the radical polymerization initiator (F) in the use of the composition (X) as an adhesive, the composition (X) is irradiated with light to cure the composition (X) to a certain extent, thereby achieving temporary adhesion, and then, the composition (X) is heated so that the composition (X) is satisfactorily cured, thereby achieving permanent adhesion.

The radical polymerization initiator (F) contains, for example, at least one compound selected from the group consisting of aromatic ketones, an acylphosphine oxide compound, an aromatic onium salt compound, organic peroxide, a thio compound (e.g., a thioxanthone compound, a thiophenyl group-containing compound, etc.), a hexaarylbiimidazole compound, a ketoxime ester compound, a borate compound, an azinium compound, a metallocene compound, an active ester compound, a compound having a carbon halogen bond, and an alkyl amine compound.

The percentage of the radical polymerization initiator (F) relative to the sum of the ene compound (A1) and the thiol compound (A2) is preferably greater than or equal to 0.05% by mass and less than or equal to 2.0% by mass. When this percentage is greater than or equal to 0.05% by mass, a photocurable property satisfactory for the temporal adhesion can be imparted to the composition (X). Moreover, when this proportion is less than or equal to 2.0% by mass, the composition (X) can be cured deeply therein when the composition (X) is irradiated with light. This percentage is more preferably greater than or equal to 0.1% by mass, much more preferably greater than or equal to 0.2% by mass, and particularly preferably greater than or equal to 0.4% by mass. Moreover, this proportion is more preferably less than or equal to 1.5% by mass, much more preferably less than or equal to 1.0% by mass, and particularly preferably less than or equal to 0.8% by mass.

The composition (X) may further contain an additive other than the above examples within a range in which the effect of the present embodiment is not excessively impaired. The additive contains, for example, at least one selected from the group consisting of a radical scavenger, a diluent, a solvent, pigment, a flexibility-imparting agent, a coupling agent, an antioxidant, a thixotropy-imparting agent, a dispersant, and the like.

The composition (X) can be prepared by mixing the above-explained components of the composition (X).

As described above, the composition (X) can be used as an adhesive. That is, the composition (X) is cured, thereby obtaining a cured material, and the cured material can bond two components (hereinafter also referred to as a first component and a second component) included in, for example, an apparatus.

The cured material according to the present embodiment is obtained by curing the composition (X). As explained above, the cured material can bond the first component and the second component to each other.

The apparatus according to the present embodiment includes a first component, a second component, and a cured material disposed between the first component and the second component to bond the first component and the second component to each other. This cured material is obtained by curing the composition (X). The apparatus is, for example, a precision instrument such as a camera module as described above but is not limited to this example. Examples of the apparatus include an electronic component such as a semiconductor element, an integrated circuit, a large scale integrated circuit, a transistor, a thyristor, a diode, and a capacitor. When the apparatus is the camera module, bonding the first component and the second component to each other is bonding members included in the camera module to each other, in other words. Examples of bonding the first component and the second component to each other include bonding a substrate and a camera housing to each other and bonding a lens unit and the camera housing to each other. Note that the first component and the second component are not limited to these examples.

A material for each of the first component and the second component is, for example, a resin such as liquid crystal polymer, a resin such as polycarbonate, a resin such as polyester, metal such as nickel and copper, ceramic, a resin such as polyimide, glass, or various types of other substrate materials but is not limited to these examples.

A method for bonding the first component and the second component to each other by the composition (X) and a method for manufacturing an apparatus including the first component, the second component, and the cured material will be described.

The composition (X) is laid between the first component and the second component. In this state, the composition (X) is heated to cure the composition (X), thereby producing a cured material. This cured material bonds the first component and the second component to each other.

When the composition (X) contains a photopolymerization initiator (H), the composition (X) laid between the first component and the second component is irradiated with light before the composition (X) is heated, so that the curing of the composition (X) proceeds to a certain extent. This enables the first component and the second component to be temporarily bonded to each other. The wavelength of the light with which the composition (X) is irradiated in this case depends on the type of the photopolymerization initiator (H) in the composition (X) and is accordingly selected. This light is, for example, ultraviolet rays. Thus, when the first component and the second component are temporarily bonded to each other, appropriately adjusting the positional relationship between the first component and the second component easily improves alignment accuracy.

A condition for heating the composition (X) is accordingly set such that the composition (X) is satisfactorily cured. A heating condition is, for example, a heating temperature of higher than or equal to 80° C. and lower than or equal to 120° C., and a heating time of longer than or equal to 30 minutes and shorter than or equal to 120 minutes.

### (Summary)

A curable composition of a first aspect contains: a curable component (A) including an ene compound (A1) and a thiol compound (A2); a stabilizer (B); a filler (C); and an anion polymerization initiator (D). The filler (C) contains silicone powder (C1). The anion polymerization initiator (D) contains a microencapsulated curing catalyst (D1).

This aspect enables a curable composition containing the ene compound (A1) and the thiol compound (A2) to be provided, a cured material obtained by curing the curable composition being able to be highly flexible, preservation stability of the curable composition being less likely to be impaired.

In a second aspect referring to the first aspect, a functional group equivalent ratio of the thiol compound (A2) to the ene compound (A1) is greater than or equal to 0.5 and less than or equal to 1.5.

This aspect enables the curable composition to have good reactivity.

In a third aspect referring to the first or second aspect, a percentage of the filler (C) is greater than or equal to 10% by mass and less than or equal to 65% by mass relative to a solid content of the curable composition.

This aspect enables curing shrinkage while the curable composition cures to be effectively reduced.

In a fourth aspect referring to the third aspect, a percentage of the silicone powder (C1) is greater than or equal to 70% by mass and less than or equal to 100% by mass relative to the filler (C).

This aspect enables the flexibility of the cured material of the curable composition to be particularly improved.

In a fifth aspect referring to any one of the first to fourth aspects, the stabilizer (B) contains an anion polymerization inhibitor.

In a sixth aspect referring to the fifth aspect, the anion polymerization inhibitor contains an organoborate compound.

In a seventh aspect referring to any one of the first to sixth aspects, the curable composition further contains a radical polymerization initiator (F).

In an eighth aspect referring to the seventh aspect, the stabilizer (B) contains a radical polymerization inhibitor.

In a ninth aspect referring to any one of the first to eighth aspects, the curable composition further contains a carbodiimide compound (E).

This aspect enables the cured material of the curable composition to be less likely to be deteriorated even at a high temperature and a high humidity, thereby improving the reliability of the cured material.

In a tenth aspect referring to any one of the first to ninth aspects, a percentage of a sum of the ene compound (A1) and the thiol compound (A2) is greater than or equal to 70% by mass relative to a portion obtained by excluding the filler (C) from a solid content of the curable composition.

This aspect enables the curable composition to have good reactivity.

In an eleventh aspect referring to any one of the first to tenth aspects, the silicone powder (C1) contains at least one of silicone composite powder or silicone resin powder.

This aspect enables the cured material of the curable composition to have low elastic modulus in the wide temperature range.

An adhesive of a twelfth aspect contains the curable composition of any one of the first to eleventh aspects.

This aspect enables an adhesive containing the curable composition to be provided, the curable composition containing the ene compound and the thiol compound, a cured material obtained by curing the curable composition being able to be highly flexible, preservation stability of the curable composition being less likely to be impaired.

### EXAMPLES

More specific examples of the present embodiment will be presented below. Note that the present embodiment is not limited to the examples below.

### 1. Preparation of Composition

Raw materials shown in Tables 1 to 3 were mixed with each other, thereby preparing a composition. Details of the raw materials shown in Tables 1 to 3 are as follows.
Ene compound #1: Isocyanuric acid EO modified di- and tri-acrylate. Manufactured by TOAGOSEI CO., LTD. Aronix M-313
Ene compound #2: Trimethylolpropane triacrylate, manufactured by OSAKA ORGANIC CHEMICAL INDUSTRY LTD., product name Viscoat #295.
Thiol compound #1: Pentaerythritol tetrakis (3-mercaptobutyrate). Manufactured by Showa Denko K.K. Product name Karenz MTPE1 (registered trademark).
Thiol compound #2: 1,3,5-tris(2-(3-sulfanylbutanoyloxy)ethyl)-1,3,5-triazinane-2,4,6-trion. Manufactured by Showa Denko K.K. Product name Karenz MTNR1 (registered trademark).
Thiol compound #3: 1,3,4,6-tetrakis(3-mercapto propyl)glycoluril. Manufactured by Shikoku Chemicals Corporation. Product name C3TS-G.
Epoxy compound: Liquiform bisphenol A-type epoxy resin. Manufactured by NIPPON STEEL Chemical & Material Co., Ltd. Product name YD-8125.
Curing catalyst #1: Microencapsulation imidazole, manufactured by ASAHI KASEI E-materials Corp., product name NOVACURE HXA9322HP.
Curing catalyst #2: Microencapsulation imidazole, manufactured by ASAHI KASEI E-materials Corp., product name NOVACURE HX3722.
Curing catalyst #3: Non-microencapsulated amine compound with solid substance denatured at an ordinary temperature. Manufactured by T&K TOKA CO., LTD. Product name Fujicure FXR-1121.
Curing catalyst #4: Non-microencapsulated, amine adduct-based latent curing catalyst. Manufactured by Ajinomoto Fine-Techno Co., Inc. AJICURE PN-40J.
Photopolymerization initiator #1: 1-hydroxy cyclohexyl-phenyl ketone, manufactured by IGM Resins B. V. product name Omnirad 184.
Photopolymerization initiator #2: 2,4,6-trimethyl benzoyl-diphenyl phosphine oxide, manufactured by IGM Resins B. V. product name Omnirad TPO G.
Stabilizer #1: Radical polymerization inhibitor. N-nitroso-N-phenyl hydroxyl amine aluminum. Manufactured by FUJIFILM Wako Pure Chemical Corporation. Q-1301.
Stabilizer #2: Anion polymerization inhibitor. Tributyl borate.
Silicone powder #1: Silicone composite powder. Manufactured by Shin-Etsu Chemical Co., Ltd. Product name KMP-605. Average particle size 2 μm. pH 3.9.
Silicone powder #2: Silicone resin powder. Manufactured by Shin-Etsu Chemical Co., Ltd. Product name KMP-706. Average particle size 2 μm. pH 6.1.
Inorganic filler #1: Silica. Manufactured by Admatechs Company Limited. Product name SE-5050.
Inorganic filler #2: Calcium carbonate. Sankyo Seifun Co., Ltd. product name Escaron #200.
Carbodiimide compound: Annular carbodiimide, manufactured by TEIJIN LIMITED, item number TCC-FP20M.

### 2. Evaluation Test

### (1) Preservation Stability

The composition was put in a light-shielding container, and the viscosity at 25° C. was measured with a B-type viscometer at a rotation speed of 20 rpm. The viscosity was continuously measured, and the amount of time required for the viscosity at 25° C. to double the initial value was defined as the index of the preservation stability.

### (2) Adhesive Strength #1

The composition was applied to an adherend made of a liquid crystal polymer (product name E463i, manufactured by Polyplastics Co., Ltd.), thereby producing a coating film having a diameter of 5 mm and a thickness of 0.5 mm. The coating film was irradiated with ultraviolet rays having a peak wavelength of 365 nm at an integrated illuminance of 500 mJ/cm². Subsequently, the shear bond strength of the composition to the adherend was measured with a shear tester.

When the adhesive strength thus measured is greater than or equal to 0.3 MPa, it can be determined that the composition is suitable for temporal adhesion of two members.

### (3) Adhesive Strength #2

The composition was applied to an adherend made of a liquid crystal polymer (product name E463i, manufactured by Polyplastics Co., Ltd.), thereby producing a coating film having a diameter of 5 mm and a thickness of 0.5 mm. The coating film was irradiated with ultraviolet rays having a peak wavelength of 365 nm at an integrated illuminance of 500 mJ/cm², and then, the coating film was heated at 80° C. for one hour to thermally cure the coating film, thereby obtaining a cured material. The shear bond strength of the cured material to the adherend was measured with the shear tester.

### (4) Shrinkage Ratio

On a glass pane, a release film made of polyethylene terephthalate was placed, and on the release film, a spacer made of silicone, having a size 5 mm×150 mm in plan view, having a thickness of 0.5 mm, and having a space open upward and downward was placed. After the space in the spacer was filled with the composition, a release film made of polyethylene terephthalate was placed on an upper surface of the spacer, and on the release film, a glass pane was placed. From above the glass pane placed on an upper side toward the composition in the space, the composition was irradiated with ultraviolet rays having a peak wavelength of 365 nm at an integrated illuminance of 500 mJ/cm². Subsequently, the composition was heated at 80° C. for one hour to thermally cure the composition, thereby manufacturing a cured material. Based on JIS K5600, the shrinkage ratio was calculated from the specific gravity of the composition and the specific gravity of the cured material.

### (5) Elastic Modulus (Storage Elastic Modulus)

On a glass pane, a release film made of polyethylene terephthalate was placed, and on the release film, a spacer made of silicone, having a size 5 mm×50 mm in plan view, having a thickness of 0.5 mm, and having a space open upward and downward was placed. After the space in the spacer was filled with the composition, a release film made of polyethylene terephthalate was placed on an upper surface of the spacer, and on the release film, a glass pane was placed. rom above the glass pane placed on an upper side toward the composition in the space, the composition was irradiated with ultraviolet rays having a peak wavelength of 365 nm at an integrated illuminance of 500 mJ/cm². Subsequently, the composition was heated at 80° C. for one hour, thereby manufacturing a cured material. On the cured material, a tensile method of a dynamic viscoelastic test (DMA) was performed based on JIS K7244-4. The dynamic viscoelastic test (DMA) was conducted by using model number DMA7100 manufactured by Hitachi High-Tech Science Corporation as a measurement device at a frequency of 1.0 Hz, and at a rate of temperature rise of 10° C./min. From the result, a maximum value of the elastic modulus (storage elastic modulus) of the cured material in the range from −60° C. to 260° C. was calculated.

The results are shown in Tables 1 to 3 below.

TABLE 1

| | | Example | | | | | | |
|---|---|---|---|---|---|---|---|---|
| | | 1 | 2 | 3 | 4 | 5 | 6 | 7 |
| Raw | Ene Compound #1 | 32.4 | 27.2 | 33.9 | | 32.4 | 32.4 | 30.0 |
| Material/ | Ene Compound #2 | | | | 21.9 | | | |
| part by mass | Thiol Compound #1 | 31.3 | | 14.9 | | 31.3 | 31.3 | 28.9 |
| | Thiol Compound #2 | | 36.5 | | 41.8 | | | |
| | Thiol Compound #3 | | | 14.9 | | | | |
| | Epoxy Compound | | | | | | | |
| | Stabilizer #1 | 0.1 | 0.1 | 0.1 | 0.1 | 0.1 | 0.1 | 0.1 |
| | Stabilizer #2 | 0.1 | 0.1 | 0.1 | 0.1 | 0.1 | 0.1 | 0.1 |
| | Silicone Powder #1 | 30.0 | 30.0 | 30.0 | 30.0 | 30.0 | | 30.0 |
| | Silicone Powder #2 | | | | | | 30.0 | |
| | Inorganic Filler #1 | | | | | | | |
| | Inorganic Filler #2 | | | | | | | |
| | Curing Catalyst #1 | 5.7 | 5.7 | 5.7 | 5.7 | | 5.7 | 5.3 |
| | Curing Catalyst #2 | | | | | 5.7 | | |
| | Curing Catalyst #3 | | | | | | | |
| | Curing Catalyst #4 | | | | | | | |
| | Carbodiimide Compound | | | | | | | 5.2 |
| | Photopolymerization | 0.3 | 0.3 | 0.3 | 0.3 | 0.3 | 0.3 | 0.3 |
| | Initiator #1 | | | | | | | |
| | Photopolymerization | 0.1 | 0.1 | 0.1 | 0.1 | 0.1 | 0.1 | 0.1 |
| | Initiator #2 | | | | | | | |
| | Total | 100.0 | 100.0 | 100.0 | 100.0 | 100.0 | 100.0 | 100.0 |
| Functional Group Equivalent Ratio | | 1.0 | 1.0 | 1.0 | 1.0 | 1.0 | 1.0 | 1.0 |
| ((A2)/(A1)) of Thiol Compound (A2) | | | | | | | | |
| Relative to Ene Compound (A1) | | | | | | | | |
| Percentage (% by mass) of Filler | | 30 | 30 | 30 | 30 | 30 | 30 | 30 |
| (C) in Composition | | | | | | | | |
| Percentage (% by mass) of Silicone | | 100.0 | 100.0 | 100.0 | 100.0 | 100.0 | 100.0 | 100.0 |
| Powder Relative to Filler (C) | | | | | | | | |
| Percentage (% by mass) of Sum of Ene | | 91.0 | 91.0 | 91.0 | 91.0 | 91.0 | 91.0 | 84.2 |
| Compound and Thiol Compound relative | | | | | | | | |
| to Solid Content except for Filler | | | | | | | | |
| Evaluation | Storage Stability (hour) | >72 | >72 | >72 | >72 | >72 | >72 | >72 |
| | Adhesive Strength #1(Mpa) | 1.5 | 1.5 | 1.5 | 1.5 | 1.5 | 1.5 | 1.0 |
| | Adhesive Strength #2(Mpa) | 6 | 7 | 7 | 6 | 7 | 6 | 9 |
| | Shrinkage Ratio (%) | 4.5 | 4.5 | 4.5 | 4.5 | 4.5 | 4 | 4 |
| | Elastic Modulus (GPa) | 1.5 | 1.6 | 1.7 | 1.6 | 1.5 | 3.0 | 1.7 |

TABLE 2

| | | | | | | Comparative | |
|---|---|---|---|---|---|---|---|
| | | Example | | | | Example | |
| | | 8 | 9 | 10 | 11 | 1 | 2 |
| Raw | Ene Compound #1 | 27.2 | 24.2 | 36.5 | 21.4 | 34.0 | 34.0 |
| Material/ | Ene Compound #2 | | | | | | |
| part by mass | Thiol Compound #1 | 26.3 | 23.4 | 35.2 | 20.7 | 32.8 | 32.8 |
| | Thiol Compound #2 | | | | | | |
| | Thiol Compound #3 | | | | | | |
| | Epoxy Compound | | | | | | |
| | Stabilizer #1 | 0.1 | 0.1 | 0.1 | 0.1 | 0.1 | 0.1 |
| | Stabilizer #2 | 0.2 | 0.3 | 0.1 | 0.1 | 0.1 | 0.1 |
| | Silicone Powder #1 | 30.0 | 30.0 | 15.0 | 20.0 | 30.0 | 30.0 |
| | Silicone Powder #2 | | | | 30.0 | | |
| | Inorganic Filler #1 | | | | | | |
| | Inorganic Filler #2 | | | | | | |
| | Curing Catalyst #1 | 10.7 | 14.3 | 6.4 | 3.8 | | |
| | Curing Catalyst #2 | | | | | | |
| | Curing Catalyst #3 | | | | | 2.7 | |
| | Curing Catalyst #4 | | | | | | 2.7 |
| | Carbodiimide Compound | 5.2 | 7.5 | 6.3 | 3.7 | | |
| | Photopolymerization | 0.3 | 0.2 | 0.4 | 0.2 | 0.3 | 0.3 |
| | Initiator #1 | | | | | | |
| | Photopolymerization | 0.1 | 0.1 | 0.1 | 0.04 | 0.1 | 0.1 |
| | Initiator #2 | | | | | | |
| | Total | 100.0 | 100.0 | 100.0 | 100.0 | 100.0 | 100.0 |
| Functional Group Equivalent Ratio | | 1.0 | 1.0 | 1.0 | 1.0 | 1.0 | 1.0 |
| ((A2)/(A1)) of Thiol Compound (A2) | | | | | | | |
| Relative to Ene Compound (A1) | | | | | | | |
| Percentage (% by mass) of Filler | | 30 | 30 | 15 | 50 | 30 | 30 |
| (C) in Composition | | | | | | | |
| Percentage (% by mass) of Silicone | | 100.0 | 100.0 | 100.0 | 100.0 | 100.0 | 100.0 |
| Powder Relative to Filler (C) | | | | | | | |
| Percentage (% by mass) of Sum of Ene | | 76.4 | 68.0 | 84.2 | 84.2 | 95.4 | 95.4 |
| Compound and Thiol Compound relative | | | | | | | |
| to Solid Content except for Filler | | | | | | | |
| Evaluation | Storage Stability (hour) | >72 | >72 | >72 | >72 | 24 | 8 |
| | Adhesive Strength #1(Mpa) | 0.8 | 0.3 | 1.0 | 0.9 | 1.5 | 1.5 |
| | Adhesive Strength #2(Mpa) | 9 | 8 | 9 | 7 | 5 | 5 |
| | Shrinkage Ratio (%) | 4 | 4.5 | 5.3 | 3.6 | 4 | 4 |
| | Elastic Modulus (GPa) | 1.5 | 1.6 | 2.8 | 2.3 | 1.5 | 1.5 |

TABLE 3

| | | Comparative Example | | | | | |
|---|---|---|---|---|---|---|---|
| | | 3 | 4 | 5 | 6 | 7 | 8 |
| Raw | Ene Compound #1 | 32.5 | 46.3 | 25.5 | 25.5 | 51.0 | 53.5 |
| Material/ | Ene Compound #2 | | | | | | |
| part by mass | Thiol Compound #1 | 31.4 | 44.7 | 24.6 | 24.6 | | |
| | Thiol Compound #2 | | | | | | |
| | Thiol Compound #3 | | | | | | |
| | Epoxy Compound | | | | | 12.7 | 13.4 |
| | Stabilizer #1 | | 0.1 | 0.1 | 0.1 | 0.1 | 0.1 |
| | Stabilizer #2 | | 0.2 | 0.1 | 0.1 | 0.1 | 0.1 |
| | Silicone Powder #1 | 30.0 | | | | 30.0 | 30.0 |
| | Silicone Powder #2 | | | | | | |
| | Inorganic Filler #1 | | | 45.0 | | | |
| | Inorganic Filler #2 | | | | 45.0 | | |
| | Curing Catalyst #1 | 5.7 | 8.2 | 4.5 | 4.5 | 5.7 | |
| | Curing Catalyst #2 | | | | | | |
| | Curing Catalyst #3 | | | | | | |
| | Curing Catalyst #4 | | | | | | 2.7 |
| | Carbodiimide Compound | | | | | | |
| | Photopolymerization | 0.3 | 0.5 | 0.3 | 0.3 | 0.3 | 0.3 |
| | Initiator #1 | | | | | | |
| | Photopolymerization | 0.1 | 0.1 | 0.1 | 0.1 | 0.1 | 0.1 |
| | Initiator #2 | | | | | | |
| | Total | 100.0 | 100.0 | 100.0 | 100.0 | 100.0 | 100.0 |
| Functional Group Equivalent Ratio | | 1.0 | 1.0 | 1.0 | 1.0 | 0.0 | 0.0 |
| ((A2)/(A1)) of Thiol Compound (A2) | | | | | | | |
| Relative to Ene Compound (A1) | | | | | | | |
| Percentage (% by mass) of Filler | | 30 | 0 | 45 | 45 | 30 | 29.99 |
| (C) in Composition | | | | | | | |
| Percentage (% by mass) of Silicone | | 100.0 | — | 0.0 | 0.0 | 100.0 | 100.0 |
| Powder Relative to Filler (C) | | | | | | | |
| Percentage (% by mass) of Sum of Ene | | 91.2 | 91.0 | 90.9 | 90.9 | — | — |
| Compound and Thiol Compound relative | | | | | | | |
| to Solid Content except for Filler | | | | | | | |
| Evaluation | Storage Stability (hour) | 24 | >72 | >72 | >72 | >72 | >72 |
| | Adhesive Strength #1(Mpa) | 1.5 | 2.5 | 3.5 | 3.5 | 3 | 3 |
| | Adhesive Strength #2(Mpa) | 6 | 7 | 7 | 7 | 3 | 3 |
| | Shrinkage Ratio (%) | 4.5 | 8 | 4.5 | 4.5 | 6 | 7 |
| | Elastic Modulus (GPa) | 1.5 | 3.5 | 8.0 | 8.0 | 1.7 | 1.7 |

As can be seen from the results above, the preservation stability of the composition was high, and the elastic modulus of the cured material was reduced in Examples 1 to 11 in each of which the composition containing the ene compound, the thiol compound, the silicone powder, and the microencapsulated curing catalyst was prepared. Of these examples, Examples 7 to 11 in each of which a carbodiimide compound was blended in the composition showed that the evaluation of the adhesive strength after heating tends to be high.

In contrast, in Comparative Examples 1 and 2 in each of which no microencapsulated curing catalyst was blended but a latent curing catalyst other than the microencapsulated curing catalyst was blended in the composition, the elastic modulus of the cured material was low, but the preservation stability was low. Also in Comparative Example 3 in which no stabilizer was blended in the composition, the preservation stability of the composition was low. Moreover, in Comparative Example 4 in which no silicone powder was blended in the composition, the preservation stability of the composition was high, but the elastic modulus of the cured material was low, and since no filler other than the silicone powder was blended in the composition, the shrinkage ratio at the curing was high. Moreover, in Comparative Examples 5 and 6 in each of which no silicone powder was blended but an inorganic filler was blended in the composition, and therefore, the elastic modulus of the cured material was high.

Moreover, in Comparative Examples 7 and 8 in which each of which no ene compound was blended but an epoxy compound was blended in the composition, no difference in evaluation of the preservation stability was observed between Comparative Example 7 in which the microencapsulated curing catalyst and the silicone powder were blended in the composition and Comparative Example 8 in which no microencapsulated curing catalyst was blended but the silicone powder was blended in the composition. Therefore, it was clarified that the problem that blending the silicone powder reduces the preservation stability is a problem specific to the case where the ene compound and the thiol compound are used, and the present embodiment can solve this problem.

1. A curable composition comprising:
a curable component (A) including an ene compound (A1) and a thiol compound (A2);
a stabilizer (B);
a filler (C); and
an anion polymerization initiator (D),
the filler (C) containing silicone powder (C1),
the anion polymerization initiator (D) containing a microencapsulated curing catalyst (D1).

2. The curable composition of claim 1, wherein
a functional group equivalent ratio of the thiol compound (A2) to the ene compound (A1) is greater than or equal to 0.5 and less than or equal to 1.5.

3. The curable composition of claim 1, wherein
a percentage of the filler (C) is greater than or equal to 10% by mass and less than or equal to 65% by mass relative to a solid content of the curable composition.

4. The curable composition of claim 3, wherein
a percentage of the silicone powder (C1) is greater than or equal to 70% by mass and less than or equal to 100% by mass relative to the filler (C).

5. The curable composition of claim 1, wherein
the stabilizer (B) contains an anion polymerization inhibitor.

6. The curable composition of claim 5, wherein
the anion polymerization inhibitor contains an organoborate compound.

7. The curable composition of claim 1, further comprising a radical polymerization initiator (F).

8. The curable composition of claim 7, wherein
the stabilizer (B) contains a radical polymerization inhibitor.

9. The curable composition of claim 1, further comprising a carbodiimide compound (E).

10. The curable composition of claim 1, wherein
a percentage of a sum of the ene compound (A1) and the thiol compound (A2) is greater than or equal to 70% by mass relative to a portion obtained by excluding the filler (C) from a solid content of the curable composition.

11. The curable composition of claim 1, wherein
the silicone powder (C1) contains at least one of silicone composite powder or silicone resin powder.

12. An adhesive comprising the curable composition of claim 1.
